(19) United States
(12) Patent Application Publication
(10) Pub. No.: US 2018/0080580 A1
(43) Pub. Date: Mar. 22, 2018

(54) PREFORMED AND REUSABLE BUNDLING STRAP

(71) Applicant: Henry Trevor Coulter, SANTA MONICA, CA (US)

(72) Inventor: Henry Trevor Coulter, SANTA MONICA, CA (US)

(21) Appl. No.: 15/671,492

(22) Filed: Aug. 8, 2017

Related U.S. Application Data
(60) Provisional application No. 62/398,404, filed on Sep. 22, 2016.

(51) Int. Cl. F16L 3/233; H02G 3/30; F16L 3/08

(52) U.S. Cl. CPC F16L 3/2336; H02G 3/30; B65D 63/10; F16L 3/2338; F16L 3/08

(57) ABSTRACT

A cable tie structure for bundling cables may include a preformed strap body having a convex inner surface, the preformed strap body comprising a receiver end and a toothed end, the toothed end having a plurality of teeth extending from at least a portion of the inner surface and designed to engage with the receiver end. The locking head may include an L-shaped overhand retainer arm formed of a side wall extending substantially perpendicularly from the strap body; an upper wall extending substantially perpendicularly from the side wall at an end of the side wall distal from the strap body such that the upper wall is substantially parallel to the strap body; and an open side opposite the side wall. A clip arm may extend at an angle from the strap body toward the upper wall. The clip arm may include clip arm teeth and a beveled outer edge.

### RELATED APPLICATION

This application claims priority to provisional patent application U.S. Ser. No. 62/398,404 filed on Sep. 22, 2016, the entire contents of which is herein incorporated by reference.

### BACKGROUND

The embodiments herein relate generally to organizational accessories, and more particularly, to a preformed and reusable cable and cord bundling strap with a toothed locking mechanism.

Cables and cords are part of most modern desks and computer and other electronics related cabinets. Grouping the cables into a bundle has no simple solution. Conventional bundling straps include a one-time use cable tie and wrapped plastic coils. Application of the conventional bundling systems requires two hands and full access around the cable to be bundled.

Therefore, what is needed is a preformed bundling strap that can be engaged and disengaged using only one hand and that also does not require complete access around the items to be bound.

### SUMMARY

Some embodiments of the present disclosure include a cable tie structure for bundling cables, cords, wires, and the like. The cable tie structure may include a preformed strap body having a convex inner surface, the preformed strap body comprising a receiver end and a toothed end, the toothed end having a plurality of teeth extending from at least a portion of the inner surface and designed to engage with the receiver end. The locking head may include an L-shaped overhand retainer arm formed of a side wall extending substantially perpendicularly from the strap body; an upper wall extending substantially perpendicularly from the side wall at an end of the side wall distal from the strap body such that the upper wall is substantially parallel to the strap body; and an open side opposite the side wall. A clip arm may extend at an angle from the strap body toward the upper wall. The clip arm may include clip arm teeth and a beveled outer edge.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of one embodiment of the present disclosure.

FIG. 2 is a detail perspective view of one embodiment of the present disclosure.

FIG. 3 is a rear perspective view of one embodiment of the present disclosure.

FIG. 4 is a perspective view of one embodiment of the present disclosure.

FIG. 5 is a perspective view of one embodiment of the present disclosure.

FIG. 6 is a perspective view of one embodiment of the present disclosure, shown in use.

FIG. 7 is a perspective view of one embodiment of the present disclosure, shown in use.

FIG. 8 is a perspective view of one embodiment of the present disclosure, shown in use.

FIG. 9 is a perspective view of one embodiment of the present disclosure.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used as a bundling strap for cords, cables, and wires and may comprise the following elements. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.

a. Strap Body

b. Locking Head

The various elements of the device of the present disclosure may be related in the following exemplary fashion. It is not intended to limit the scope or nature of the relationships between the various elements and the following examples are presented as illustrative examples only.

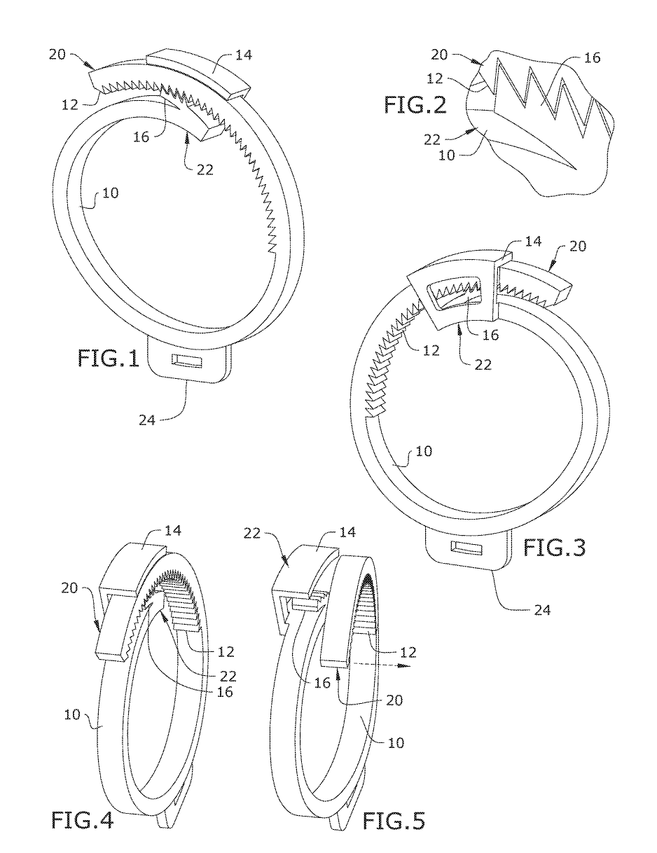

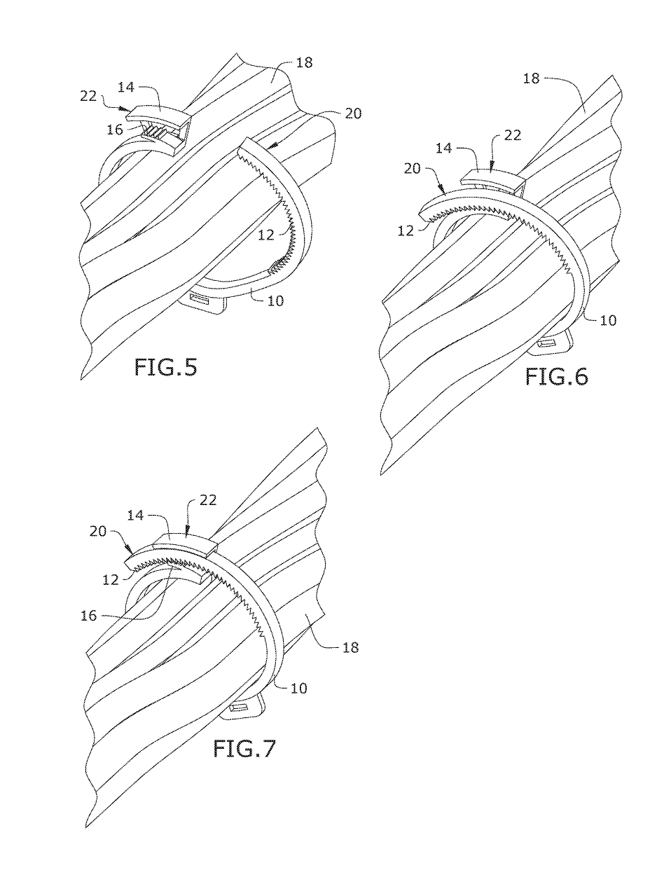

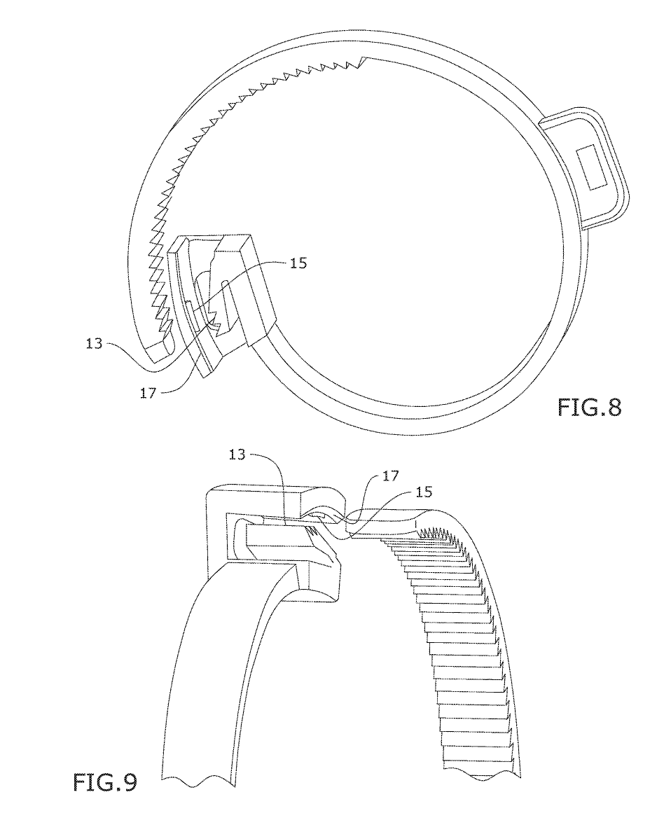

By way of example, and referring to FIGS. 1-8, some embodiments of the present disclosure include a cable tie structure for bundling items, such as cords, cables, or wires 18, the cable tie structure comprising a preformed strap body 10 having a receiver end 22 and a toothed end 20; and locking head attached to the receiver end 22, wherein the toothed end 20 is configured to engage with the locking head to secure the strap body 10 in a closed configuration.

As shown in the Figures, the strap body 10 comprises an outer surface and an inner surface, wherein the inner surface is designed to be positioned adjacent to the bundled items 18. As shown in the Figures, the inner surface has a convex curvature. As a result, the strap body 10 of the present disclosure is preformed in a curved shaped and, thus, is not flat or planar, like conventional bundling straps, when not in use.

As shown in the Figures, at least a portion of the inner surface of the strap body 10 comprises teeth 12 that are designed to engage with the locking head. In some embodiments, at least about ¼ of the inner surface, starting from the toothed end 20 may have teeth 12 extending therefrom.

As shown in the Figures, the locking head may comprise an overhand retainer arm 14 extending from the strap body 10. The overhand retainer arm 14 may be substantially L-shaped, wherein the overhand retainer arm 14 may comprise a side wall extending substantially perpendicularly from the strap body 10, an upper wall extending substantially perpendicularly from the side wall at an end of the side wall distal from the strap body 10 such that the upper wall is substantially parallel to the strap body 10, and an open side opposite the side wall. In other words, an edge of the upper wall distal from the side wall may be free and, thus, not attached to the strap body 10. As a result, the side wall and the upper wall together may create the L-shape and a side opposite the side wall may be open. A clip arm 16 may extend at an angle from the strap body 10 towards the overhand retainer arm 14. The clip arm 16 may be spaced from the upper wall of the overhand retainer arm 14 by a distance that allows the toothed end 20 of the strap body 10 to snugly fit between the clip arm 16 and the upper wall of the overhand retainer arm 14. In some embodiments, an upper surface of the clip arm 16 (i.e., the surface facing the overhand retainer arm 14, may comprise clip arm teeth 13. However, other embodiments of the clip arm 16 may include a smooth upper surface.

As shown in the Figures, an outer surface of the clip arm 16 (i.e. the surface distal from the side wall of the overhand retainer arm 14), may be a beveled edge 17, which may provide guidance for sliding the toothed end 20 into the locking head from a side position. Moreover, an outer edge of the upper wall of the overhand retainer arm 14 may include a lip 15 extending downward toward the clip arm 16. The lip 15 may function as a locking barb to help keep the strap body 10 aligned within the locking head when in use.

Some embodiments of the device of the present disclosure may further comprise various attachments, such as a hanger 24, wherein the hanger 24 may be used to position the cables 18 in a specific orientation with respect to another structure, such as in a straight line along the back of a desk. The hanger 24 may extend from an outer surface of the strap body 10. The hanger 24 may comprise an extension with an orifice, as shown in the Figures, wherein the hanger 24 may be hung by inserting a pin, nail, screw, or other conventional fastener through the orifice.

Embodiments of the present disclosure may also comprise an RFID tag embedded therein for identification and tracking purposes.

The device of the present disclosure may be made of any suitable materials. For example, the bands may be made of recycled or recyclable material. Moreover, the specific type of material used may be dependent on the intended use of the device. Thus, the materials used for the cable tie structure when it is intended to be used in very cold environments may be different than a material used for the cable tie structure when it is intended to be used in very hot environments. Additionally, some embodiments of the cable tie structure may have an inner surface of the band made from a soft material to avoid damage to the bundled items. Alternatively, a soft cushion like material may be adhered or otherwise attached to the inner surface of the strap body 10. Lastly, the strap body 10 may be colored specifically for bundled wire identification, such as when used with fiber optic cables.

To use the device of the present disclosure, a user may slip the preformed strap body 10 around cables 18 to be bound. The user may then either slide the toothed end 20 into the locking head from a side position, allowing the teeth 12 to engage with the clip arm 16, or the user may insert the toothed end 20 into an opening at a distal end of the receiver end 22 between the overhand retainer arm 14 and the clip arm 16. The user may then tighten the strap body 10 as needed by simply squeezing the strap body 10, causing the toothed end 20 to be inserted further through the locking head. To remove the cable tie structure of the present disclosure, a user may simply press the strap body 10 downward and away from the side wall of the overhand retainer arm 14. As a result, the teeth 12 on the strap body 10 may disengage with the clip arm 16. Accordingly, both bundling and unbundling may be done quickly with one hand.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A cable tie structure for bundling cords, cables, and wires, the cable tie structure comprising:
a preformed strap body having a convex inner surface, the preformed strap body comprising a receiver end and a toothed end, the toothed end comprising a plurality of teeth extending from at least a portion of the inner surface;
a locking head attached to the receiver end, the locking head comprising:
an L-shaped overhand retainer arm comprising:
a side wall extending substantially perpendicularly from the strap body;
an upper wall extending substantially perpendicularly from the side wall at an end of the side wall distal from the strap body such that the upper wall is substantially parallel to the strap body; and
an open side opposite the side wall; and
a clip arm extending at an angle from the strap body toward the upper wall;
wherein:
the toothed end is designed to engage with the locking head to secure the strap body in a closed configuration.

2. The cable tie structure of claim 1, wherein the preformed strap body has a circular shape when the toothed end is engaged with the locking head.

3. The cable tie structure of claim 1, wherein an upper surface of the clip arm comprises a plurality of clip arm teeth.

4. The cable tie structure of claim 1, wherein an outer surface of the clip arm comprises a beveled edge.

5. The cable tie structure of claim 1, wherein an outer edge of the upper wall of the overhand retainer arm comprises a lip extending toward the strap body.

6. The cable tie structure of claim 1, further comprising a hanger extending from the strap body.

7. A cable tie structure for bundling cords, cables, and wires, the cable tie structure comprising:
a preformed strap body having a convex inner surface, the preformed strap body comprising a receiver end and a toothed end, the toothed end comprising a plurality of teeth extending from at least a portion of the inner surface;
a locking head attached to the receiver end, the locking head designed to engage with the toothed end to secure the strap body in a closed configuration
